(19) United States
(12) Patent Application Publication
(10) Pub. No.: US 2003/0009769 A1
(43) Pub. Date: Jan. 9, 2003

(54) Trusted application level resource advisor

(76) Inventors: Debra Hensgen, Redwood City, CA (US); Ludovic Pierre, Tokyo (JP); Jean-Rene Menand, Los Altos, CA (US); Steven Szymanski, Mountain View, CA (US)

Correspondence Address: Rory D. Rankin, Conley, Rose, & Tayon, P.C., P.O. Box 398, Austin, TX, 78767, US

(21) Appl. No.: 10/179,144

(22) Filed: Jun. 24, 2002

Related U.S. Application Data
(60) Provisional application No. 60/300,910, filed on Jun. 25, 2001.

(51) Int. Cl. H04N 7/173; H04N 7/16; G06F 9/00; G06F 9/46

(52) U.S. Cl. 725/131; 725/132; 725/139; 709/329

(57) ABSTRACT

A method and mechanism for managing resources in a receiving device. A privileged application-level resource advisor may be included in individual receivers which are manufactured by different hardware manufacturers, each possibly having different resources, and each possibly running operating systems and/or middleware written by different vendors. The advisor is configured to communicate with the middleware and/or operating system of a receiving device in order to affect resource usage. Subsequent to detecting a resource contention problem, the resource advisor may determine how to resolve the contention problem. Subsequent to being authenticated by the middleware and/or operating system, the resource advisor may then affect the resolution by itself, or it may affect the resolution by providing input to the operating system, middleware, or other resource managing component of the IRD. Network operators may supply a single version of the resource advisor which is manufactured to a single interface specification. The same resource advisor may be used to allocate resources on each of the receivers in a heterogeneous collection.

### CROSS REFERENCE TO RELATED APPLICATIONS

This application claims benefit of priority to Provisional Application Serial No. 60/300,910 filed Jun. 25, 2002.

### BACKGROUND OF THE INVENTION

1. Field of the Invention

The invention relates generally to interactive television systems and, more particularly, to a system and method for arbitrating resources.

2. Description of Related Art

Interactive television systems provide a means to deliver interactive content as well as ordinary television audio and video to a large number of subscribers. Programs broadcast by these systems may incorporate television audio and video, still images, text, interactive graphics and applications, and many other components. They may also provide a number of services, such as commerce via the television, electronic program guides (EPGs), video-on-demand, and other interactive applications to viewers. The interactive content of the interactive television signal may therefore include application code, data associated with the audio and video, control signals, raw data and many other types of information. This information can be combined into a single signal or several signals for transmission to a receiver connected to the viewer's television or the provider can include only a subset of the information, possibly with resource locators. Such resource locators can be used to indicate alternative sources of interactive and/or audio-video information or may be used to reference other information in the broadcast stream. For example, the resource locator could take the form of a world wide web universal resource locator (URL). Both the interactive content and the audio and video data may be delivered to subscribers in response to a request from the subscriber. Alternatively, the data may be “pushed” to the subscribers. That is, the data is delivered to each of the subscribers, regardless of whether or not the subscribers requested the data.

The interactive functionality of the television is generally controlled by an integrated receiver/decoder (IRD) or similar mechanism, frequently incorporated into a set-top box, connected to the television. The IRD receives the signal transmitted by a broadcast service provider or system operator, separates the interactive portion from the audio-video portion and decompresses the respective portions of the signal. The IRD may use the interactive information to, for example, execute an application while the audio-video information is transmitted to the television. The IRD may combine the audio-video information with interactive graphics or audio generated by the interactive application prior to transmitting the information to the television or other display device. The interactive graphics and audio may present additional information to the viewer or may prompt the viewer for input. In addition, the IRD may provide viewer input or other information to the broadcast service provider via a return path. Information referenced by resource locators may be obtained via the return path or over different media, for example, through an always-on return channel via modem.

Interactive content such as application code or information relating to television programs is sometimes broadcast in a repeating format. In other words, each piece of information is broadcast a first time, then each is transmitted a second time, and so on. The cycle is repeated so that each piece of interactive data is transmitted, for example, every ten seconds. The pieces of information which are broadcast in this manner form what may be referred to as a “carousel.” Frequently, a single carousel is transported as a contiguous data stream. However, it is also possible to multiplex two or more carousels in a single data stream. As an alternative, or in addition, to using a carousel format, some systems may utilize a return path to request and/or receive interactive content.

Broadcast systems (e.g., interactive television systems) may transmit information in a carousel format in order to allow receivers in the system to selectively obtain particular pieces of information in the carousel without requiring communication via a return path from the receivers to the server. If a particular receiver needs a particular piece of information, it can simply wait until the next time that piece of information is broadcast, and then extract the information from the broadcast data stream. Other receivers in the system can operate in a similar manner, each receiver waiting for the information it needs, and then using only that information. By employing carousels to broadcast information, the system may eliminate the need to connect each of the receivers with the server and further eliminate the need for the server to process individual requests for information. Generally, a broadcast signal may include a number of programs which in turn may include a number of audio/video streams and/or data streams. Data streams may be used to carry data such as interactive application data, subtitle information, or other data.

The pieces of information, or data objects, in a carousel may be intended to be combined in a single object data stream to form a program. This program may also contain streaming data such as audio or video. For example, an interactive television game show may combine television audio and video with interactive content such as application code which allows users to answer questions. Another example would be a news program which combines audio and video with application code that inserts current stock prices in a banner at the bottom of the screen. (It should be noted that many types of programs are possible, and it is not necessary to include either audio, video or interactive content with any particular program. A program might contain only audio and interactive data (e.g., an interactive radio program,) or it might contain only interactive data (e.g., an interactive weather program that does not contain audio or video streams.) Typically, each program is associated with a corresponding channel and, when a channel containing a particular program is selected by the interactive television receiver, the data which is being broadcast on that channel may be downloaded and an application corresponding to the downloaded data may be started.

When applications execute on a set-top box, they require resources similar to applications executing on a personal computer. Some examples of resources which may be required by applications executing on a set-top box include memory, secondary storage, processing resources, or network access. In addition, such applications may be configured to react to viewer interaction and may make use of television-specific resources such as a tuner, section filters, display resources, and decryption resources. In a television environment, the suppliers of television programming services and accompanying data (e.g., the network and/or broadcast system operator) are responsible for the viewer experience. Because they may be required to field trouble calls—an expensive responsibility—they prefer to prevent problems in the first instance by maintaining control over the resources which are used by a set-top box. One method an operator may use to maintain control over resource usage in a set-top box involves modifying and/or customizing the operating system (OS) and/or middleware resource management mechanisms within the set-top box. However, because the operating system and/or middleware layers typically are themselves granted great privileges within the set-top box, such modifications would need to be extensively tested prior to implementing such modifications. Further, downloading a new operating system and/or middleware layer each time the resource management policy changes is costly in terms of both time and resources. Still further, different modifications may be required for set-top boxes from different manufacturers.

What is desired is a method and mechanism for enabling the implementation of resource management policies without requiring modification of operating system or middleware level software.

### SUMMARY OF THE INVENTION

The problems outlined above may be solved by various embodiments of the invention described herein.

The present invention relates generally to a privileged application for use in managing resources in a receiving device, including a system and method for constructing, transmitting, and executing the downloaded privileged application in such a way that middleware and/or operating system software on a receiver may communicate with the privileged application when resource contention occurs. The privileged application may be downloaded to individual receivers which are manufactured by different hardware manufacturers, each possibly having a different collection of devices attached to it, and each possibly running operating systems and/or middleware written by different software vendors.

In one embodiment, an application-level IRD resource advisor is configured to communicate with the middleware or operating system of an IRD in order to affect resource usage. In one embodiment, the resource advisor is configured to detect certain events and perform queries concerning current resource usage, resource requirements, and process status. Subsequent to assessing a resource contention problem, the resource advisor may determine how to resolve the contention problem. The resource advisor may then affect the resolution by itself, or it may affect the resolution by providing input to the operating system, middleware, or other resource managing component of the IRD.

In one embodiment, the resource advisor includes application programming interfaces (APIs) that may be utilized to detect and resolve resource contention problems. Network operators may supply a single version of the resource advisor which is manufactured to a single interface specification. The same resource advisor may then be used to allocate resources on a heterogeneous collection of receivers. Alternatively, different resource advisors for each different receiver configuration may be utilized. The receivers may be manufactured by different hardware manufacturers, each possibly having a different collection of devices embedded in it or attached to it, and each possibly running operating systems and/or middleware written by different software vendors.

### BRIEF DESCRIPTION OF THE DRAWINGS

Other objects and advantages of the invention will become apparent upon reading the following detailed description and upon reference to the accompanying drawings in which:

FIG. 1 is a diagram of one embodiment of an interactive television system.

FIG. 2 is a diagram illustrating a prior art receiver architectural model.

FIG. 3 is a diagram illustrating a prior art receiver architectural model.

FIG. 4 is a diagram illustrating an architectural model utilizing a trusted, application-level resource advisor.

FIG. 5 is a diagram illustrating one embodiment of a set-top box.

FIG. 6 illustrates one embodiment of a method for utilizing a resource advisor.

FIG. 7 is a diagram illustrating an embodiment of the functional components of a trusted, application-level, IRD resource advisor and their interaction;

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

The following description is presented to enable one of ordinary skill in the art to make and use the invention. Descriptions of specific embodiments and applications are provided only as examples and various modifications will be readily apparent to those skilled in the art. The general principles described herein may be applied to other embodiments and applications without departing from the scope of the invention. Thus, the present invention is not to be limited to the embodiments shown, but is to be accorded the widest scope consistent with the principles and features described herein. It will be understood by one skilled in the art that many embodiments are possible, such as the use of a computer system and display to perform the functions and features described herein. For purpose of clarity, the invention will be described in its application to a set top box used with a television. In addition, some details relating to technical material that are known in the technical fields related to the invention have not been included.

Interactive Television System Overview

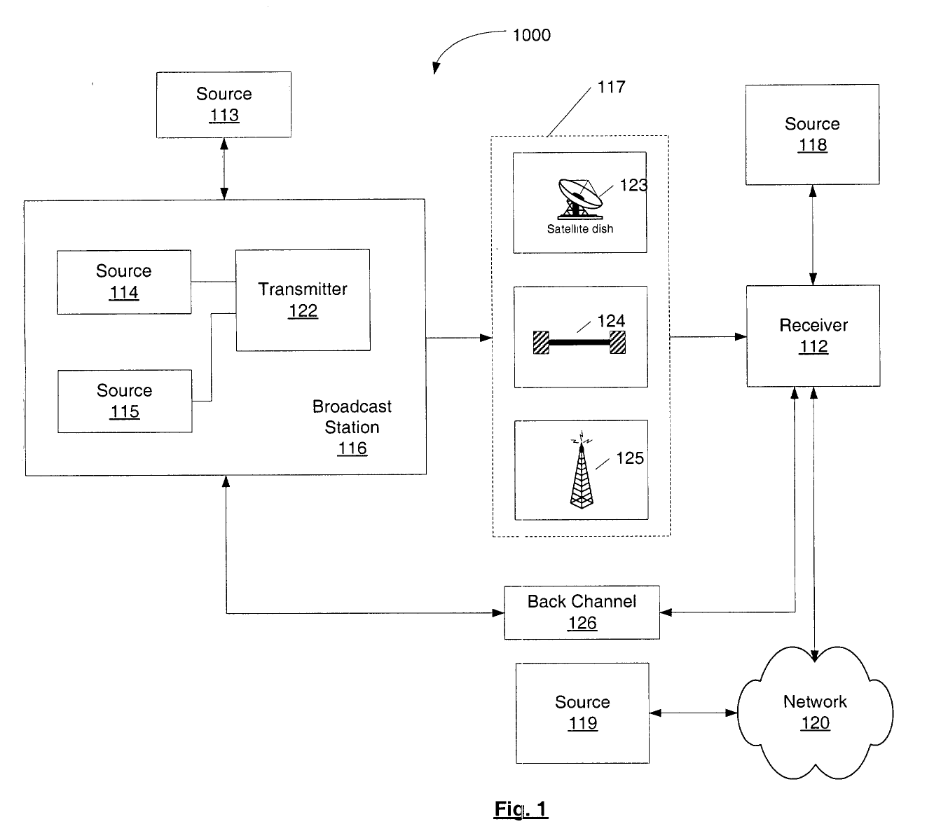

Referring to FIG. 1, one embodiment of an interactive television system 1000 is shown. In the embodiment shown, a receiving device 112 is coupled to several sources of interactive television content. Receiving device 112 generally incorporates an IRD and may be embodied in or connected to any number of suitable devices, examples of such devices include a set-top box (STB), a television (TV), a video cassette recorder (VCR), a personal video recorder (PVR), a personal digital assistant (PDA), a personal computer (PC), a video game console, or a mobile/cell phone. While the content may be delivered through many different delivery mechanisms, three exemplary mechanisms are shown in the figure.

Included in the embodiment of FIG. 1, a broadcast station 116 is coupled to a receiver 112 via a transmission medium 117 and back channel 126. In addition, receiver 112 may be coupled to a source 118 and network 120. Further, broadcast station 116 is coupled to a source 113, and network 125 is coupled to a source 119. In the embodiment shown, broadcast station 116 includes sources 114 and 115 and transmitter 122. Transmission medium 117 may comprise a satellite based system 123, a cable based system 124, a terrestrial or multiple multi-point distribution service (MMDS) based system 125, a combination of these systems, or some other appropriate system of transmission.

In the embodiment of FIG. 1, broadcast station 116 may include or be coupled to a variety of sources 113, 114, and 115 of content to be utilized and conveyed by transmitter 122. Content sources 113, 114, and 115 may include databases, application servers, other audio/video sources, or other data sources. In one embodiment, content may be created at a source 114 which may include an authoring station configured to create such content. An authoring station may include a computer workstation configured with software which aids in the development of interactive content. An authoring station may be part of broadcast station 116 in which case the conveyance of the created content may be through a local computing network, or similar configuration. Alternatively, an authoring station may be remotely located 113 from broadcast station 116. In an embodiment where authoring station is not directly coupled to broadcast station 116, the content created by a source 113 may be conveyed to broadcast station 116 via Internet, broadcast, cable, etc. In some cases, content created by at a remote location 113 may first be transferred to a storage medium, such as a CD-ROM or DVD-ROM, and transported to broadcast station 116 via more conventional means where it may be stored in a database or other storage device.

Subsequent to its creation, content from sources 113, 114 and 115 may be delivered to receiver 112 through a broadcast transmission network. This network consists essentially of a broadcast station 116 which assembles the content from sources 113, 114 and 115 and processes (e.g., digitizes, compresses and packetizes) the content, and a transmission network 117 which receives the content from broadcast station 116 and conveys it to receiving device 112. (It should be noted that receiving device 112 may be only one of many devices to which this content is distributed.) In one embodiment, broadcast station 116 includes software and/or hardware which is configured to process the content conveyed by sources 113, 114 and 115 as described above. A second delivery mechanism may include a direct point-to-point connection between receiver 112 and source of 118, which may be some type of server. This connection may be made, for example, via an ordinary telephone line. A third delivery mechanism may also be a point-to-point connection, but transmission of the content from a source 119 to receiver 112 is made via one or more shared networks 120 (e.g., over the Internet). Also illustrated in FIG. 1 is a back channel (or return path) 126 by which receiver 112 may convey data to broadcast station 116. Back channel 126 may comprise a telephone line, cable, wireless, or other connection.

One delivery mechanism, the direct point-to-point connection to a source of content, may comprise communication via an ordinary telephone line. This type of connection is typically initiated by the receiver to convey information to, or retrieve information from, a data server. Another delivery mechanism, the point-to-point connection through one or more networks, may comprise a connection between nodes on the Internet. Because data may be routed through many different shared networks in this case, it may be read, stored and written many times as it is transmitted from source 119 to receiver 112. The third delivery mechanism may include a satellite, cable or terrestrial broadcast network.

In addition to the above, the broadcast station 116 may include television-related metadata or service information (SI) embedded in the broadcast stream. The SI may, for example, list elementary stream identifiers and associate with each identifier an encoding that describes the type of the associated stream (e.g., whether it contains video or audio, which perspective it represents, or what language is being carried in the stream), television program information such as time, date, and channel.

Two common techniques which are utilized to distribute information that facilitates interactivity in set-top boxes are the carousel and walled-garden approaches. As already mentioned, the idea behind a carousel is that the transport stream acts as a distributed file system for the set-top boxes. Information that is correlated with a television program, such as statistics about an actor, an executable or interpretable program that implements the ability to play along with a game show, information concerning identifiers for alternate camera angles of a sports event, a recipe for a cooking program, or additional information on a historical event portrayed in a documentary, is placed into files or objects. A repetition factor is determined for each of the files, with files which may be needed by many viewers being repeated very often for the entire length of the program and other files, perhaps containing data corresponding to an answer for a quiz show being transmitted only a few times over a much shorter period. Typically, files may be divided into equal sized portions which are to be transmitted together. As in most network protocols, these portions are then carried in the payloads of transport stream packets. These portions may then be multiplexed with packets carrying video audio, and SI type data. Depending upon the system, the portions may be cached automatically by each set-top box on which the viewer has selected a particular service corresponding to the portion. Other of the portions may not be downloaded until the viewer's interactions with the set-top box require them.

An alternative mechanism by which set-top boxes may acquire data to be used to provide viewer interactivity is sometimes referred to as a walled-garden or server-based approach. In this approach, pointers identifying locations (e.g., URLs) where the interactive data may be obtained are multiplexed into the transport streams. When a set-top box needs to acquire the data referenced by this location, it contacts a proxy server via either a dial-up or always on return channel. The proxy server would then acquire the information needed to satisfy the set-top box's request if it has not already cached that information. Depending upon the capabilities of the set-top boxes, a proxy server may also transcode the requested data prior to conveying it to the set-top box.

Generally speaking, network operators maintain control over resources from the head end through the local nodes in order to control the viewing experience and affect resource usage in a manner which reflects the desires and goals of the network operator. In current deployments, IRDs are generally furnished by the operator who ensures that each IRD has sufficient resources to execute each and every application that is broadcast concurrently; hence, two viewers making exactly the same choices will execute the downloaded application identically. However, in the future, IRDs are expected to be available at retail stores, purchased by consumers that may choose from among a variety of IRDs with different capabilities made by different manufacturers, executing different operating systems and middleware. Retail IRDs may be configured to have minimally acceptable functionality according to standards that are currently being developed by the middleware and consumer electronics vendors in conjunction with broadcasters and Multi-System Operators (MSOs). This expected retail availability of IRDs will create an environment requiring flexible resource allocation that can account for both the heterogeneity among the IRDs, as well as viewer choice differences. In order to maintain some control over the viewing experience, network operators must continue to have some control over resources while also allowing a retail model which permits viewers to purchase or rent an appliance containing an IRD such as a set-top box (local node) or digital television.

Shared and Limited Resources

IRD nodes generally include resources that must be shared by competing programs within the IRD. These resources may include section filters, conditional access (CA) resources, and broadcast related resources. Included below is a brief discussion of each of the resources.

Section Filters

Generally speaking, a general purpose processor included in a given IRD node is not adequate to process all of the data that is sent on a specific frequency by the broadcast server. Further, the processor may be inadequate for sending selected video data to special purpose video decoders, selected audio data to special purpose audio decoders, and isolating interactive data associated with the currently selected service so that it can be further processed. Instead, a limited number of special purpose hardware filters may be present within the IRD which are designed to handle the task of routing received data to selected hardware components.

The processor may be used to set masks and values for these filters. When a mask, applied to a portion of a packet or set of packets, yields a value equal to the value set for the corresponding filter (to which the mask is also applied), that packet or set of packets (sometimes known as a section or table) are said to match the mask and value set for the filter. Packets that match may be further examined in software or be directly routed along an associated path inside the IRD while non-matching packets are simply ignored. Hence, video and audio are automatically routed to the special purpose processors that decode them and only requested interactive applications and data are routed to the processor. Because there are a limited number of these filters, some allocation strategy needs to be established when there are multiple concurrent applications that are available to execute on a given node. The policy should select an appropriate subset of the available applications in such as way as to increase the probability that all applications in that subset can make progress.

Additionally, there may be constraints on how long a program can wait until its request for setting a mask must be carried out. For example, the default mode of the object carousel component of the Digital Video Broadcasting: Multimedia Home Platform (DVB MHP) specification requires that an implementation can wait no longer than 500 ms after locating an object in the transport stream and caching it before re-setting the filter mask to again look for a new version of the same object.

Conditional Access Resources

In the pay-television arena, sophisticated cryptographic algorithms are generally used to protect services from use by non-validated viewers. These cryptographic algorithms typically require that new keys be frequently obtained, and often decoded. from the transport stream and that the conditional access (CA) registers be re-loaded. While allocation of these resources may be time-critical, and programming the node to correctly utilize the CA resources is difficult, it is typically not too difficult to allocate this resource to the single television watching application when a viewer is simply watching a single show. However, the issues become more complex when simultaneous recording and watching of live television or pre-recorded data is desired or when picture-in-picture facilities are utilized. Recording sometimes requires decrypting, followed by re-encryption, depending upon whether the viewer is purchasing a single viewing, unlimited viewing, or limited viewing.

Broadcast-related Resources

Resources which are typically thought of as being broadcast-specific include (1) tuners and (2) video and audio decoders (e.g., MPEG decoders), though the latter of these may also be used for information received via a return channel. It is well understood that concurrently using 2 facilities such as picture-in-picture, watching live television on a major component of the screen, and making a recording of a television program may require multiple tuners. What is less obvious is that according to the Digital Storage Media—Command and Control (DSM-CC) specification (part of the ISO/IEC 13818 standard), interactive data corresponding to a directory containing objects, all of which are components of a single interactive application, may be spread out over multiple carousels and those carousels may be transmitted via different services, some of which may be on different carrier frequencies and even others of which may be transmitted over the return channel. Hence, resource allocation must correctly determine how to allocate the tuners within an IRD.

In addition to decoding video from live broadcasts and digital recordings that flow through the set-top box, an MPEG decoder may be used by interactive applications to display an MPEG I-frame and optionally a P-frame, which, for example may have been rendered by the head-end from HTML and sent as data for the application. The MPEG decoder may be used in this way in order to leverage special purpose hardware in the IRD and allow for the efficient display of an image that might otherwise take substantial time to render given the constrained memory and processor resources of a typical device containing an IRD. However, while decoding an application-specific MPEG still-frame, which need not occupy the entire screen, video generally cannot be simultaneously rendered.

In addition to allocating processor and memory resources in an IRD, the IRD must be configured to allocate screen real estate, access to the return channel, and delivery of user events to interactive applications. Access to a return channel typically includes multiple elements, including access to a telephone line and access to buffers used to hold incoming and outgoing messages. Return channel access may be further complicated due to per-use and per-minute charges for local calls and or long-distance calls.

Screen real estate must be allocated between video and interactive applications; in the event that closed-caption or emergency information is present, care must be taken to avoid graphical overlays. Further, depending upon the IRD, handling color correctly may be a problem. Support of multiple color palettes may be difficult and when video color changes underneath a graphical overlay, the text in the overlay may blend into the background.

Although decisions concerning which applications shall receive notification of user events, such as key presses, is not trivial in a general-purpose computing environment, it is generally more complicated in an interactive television environment because of the expectations of viewers concerning interfaces. For example, a viewer might be quite surprised to see an image on the screen move around when they press a channel or volume key on a remote control.

Unique Resource Management Requirements

One complication of resource management in an interactive television environment is that the broadcaster or system operator is typically responsible for both resource allocation, as well as for the look and feel of the viewer's experience. The reason that this responsibility falls on the operator is economical and not technical, but nonetheless it complicates resource allocation, particularly with the set-top box heterogeneity that is expected to proliferate with different clients having different numbers of tuners, different numbers and types of filters, different numbers of CA sub-systems, etc. While it may not be currently viable to offload computing from one IRD node to another, it is possible to offload computing to a broadcast or proxy server and the decision as to how to balance the load between these components of the system often will need to be made dynamically.

Standards Bodies

One body working on a resource allocation framework is the international Digital Video Broadcasting (DVB) consortium. The DVB consortium is developing a specification for the Multimedia Home Platform (MHP). To some extent they have adopted the resource allocation framework from the Digital Audio Video Council (DAVIC). The current MHP solution may be seen to specialize the DAVIC mechanisms in two ways. First, it provides resource-specific instantiations that extend to most of the non-general-purpose resources described above. Second, it allows applications that were “written to be executed together” to arbitrate for those resources between themselves. However, it does not provide any way for reflecting resource arbitration on these heterogeneous nodes to an agent of the operator. Since it does not provide for such an agent, it does not include a description as to how such an agent might be downloaded to a box, how it might be authenticated, or how it might be organized so as to properly account for receiver resources, user interaction, and an operator's overall regard for quality.

The DAVIC Resource Framework

The DAVIC framework specifies some classes and interfaces that may be used for resource negotiation and notification, and is based upon the assumption that requests for individual resources, and hence the related APIs, are necessarily resource-dependent.

Generally speaking, the DAVIC framework includes four interfaces: (1) the ResourceClient interface; (2) the ResourceServer interface; (3) the ResourceProxy interface; and (4) the ResourceStatusListener interface. In addition, the DAVIC framework includes one class: the ResourceStatusEvent class.

A client application typically implements the ResourceClient interface if it wants to be informed of any lost resources or it is capable of negotiating for resources. The client application accesses the resource through a proxy which may be either in the application space or at a lower level. If it is at a lower level, it is often implemented in the same object that implements the ResourceServer interface. The objects that implement the ResourceProxy and the ResourceServer interfaces implement resource-specific APIs for obtaining/releasing access to resources. A monitoring application can subscribe to be informed of changes in possession of resources by implementing a ResourceStatusListener interface. When one of these changes occurs, the object implementing the ResourceServer interface constructs an appropriate resource-specific ResourceStatusEvent object (of a class derived from the ResourceStatusEvent class) containing information about the change that occurred and passes the constructed object to the ResourceStatusListner.

The ResourceServer interface is implemented by objects representing low level resources. In addition to implementing resource-specific APIs for obtaining and releasing resources, this server is responsible for notifying interested listeners of changes in the state of the resources it manages. In order to be informed of which listeners to notify of those changes, it implements addResourceStatusListener( ) and removeResourceStatusListener( ). Applications that wish to use one of the resources managed by the resource server must do so via an object that implements the ResourceProxy interface.

The ResourceProxy interface represents a particular resource within the application. The object that implements the ResourceProxy interface is also expected to implement resource-specific APIs. In addition to these resource-specific APIs, this interface implements the method getClient( ) which is used to determine to which object the resource has currently been granted.

The ResourceClient interface is used to notify clients that they are about to lose or have already lost access to a resource and/or to request that a client release a resource. The methods notifyRelease( ) and release( ) are used to notify of loss or impending loss, respectively, of the resource. The requestRelease( ) method can be used to negotiate for the resource.

An object may implement the ResourceStatusListener interface to request to be kept informed of changes in state of a resource. This interface requires that the application implement the statusChanged( ) method which is passed an object of the type ResourceStatusEvent.

Finally, objects derived from the ResourceStatusEvent class are passed to listeners that have registered for appropriate resource state modifications. This class returns an object (of type Object), which is specific to the resource.

Resource Management in DVB MHP

The resource management in DVB MHP for many resources, as shown in Table 1 below, generally follows the DAVIC resource framework summarized above, with a few restrictions and extensions.

In MHP, the getclient( ) method of the Resource Proxy is only expected to behave properly when the resource is currently allocated via the ResourceProxy on which this method is invoked.

Also, in MHP, the only Resource Clients that must implement the release( ) method are those clients of the connection oriented return channel resource, because it is the only resource where time to cleanup is of practical use.

Also, in MHP, the Resource Client's requestData parameter must implement the java.rmi.Remote interface. The requestData parameter is obtained via a resource-specific API to the object that implements the ResourceProxy interface. If an incorrect type (not implementing java.rmi.Remote interface) is passed via the ResourceProxy call, then a null value in this parameter is passed to the currently owning client. However, if the object making the current request and the object currently holding the resource are in the same application, other application-specific means may be used to determine the reason for the request.

As can be seen from the table, methods for sharing the CA resources, broadcast and return channel resources, screen real estate, user inputs, and section filters among cooperating applications are provided.

As an example, when an application wishes to subscribe to particular key events it may request either exclusive reservation of those key events as a set, or it may request shared access. As with all resources, the MHP platform uses a policy based on priorities, as well as platform-specific arbitration (in the embedded OS/middleware) to determine whether and when to grant such requests.

In summary, even though these specifications do provide a way for applications to release certain resources to other applications, they do not provide for the downloading of a (trusted), application-independent, network-operator-controlled resource allocation agent (or data to drive such an agent which may be already installed in hardware or software).

TABLE 1
Use of DAVIC framework by MHP

| | Implements | | |
|---|---|---|---|
| Resource | ResourceServer Interface | ResourceProxy Interface | ResourceStatusEvent Classes |
| CA | CAModuleManager | DescramblerProxy | DescramblingStartedEvent |
| Modules | | DescramblingStoppedEvent | |
| Broadcast | NetworkInterfaceManager | NetworkInterfaceController | NetworkInterfaceReleasedEvent |
| Network | | | NetworkInterfaceReservedEvent |
| Section | SectionFilterGroup | | FilterResourcesAvailableEvent |
| Filters | | | ForcedDisconnectEvent |
| Screen | HScreenDevice | | HscreenDeviceReleasedEvent |
| | | | HscreenDeviceReservedEvent |
| Return | CInterfaceManager | ConnectionRCInterface | RCInterfaceReleasedEvent |
| Channel | | | RCInterfaceResrvedEvent |
| User Events | EventManager | RepositoryDescriptor | |

Operator Controlled Distributed Resource Allocation

As mentioned above, applications executing within a set-top box, appliance, or similar device require the use of resources. When a consumer acquires an IRD (either using a retail model or directly from the network operator), and the IRD is attached to the operator's network, the operator may wish to permit the IRD to be used to execute applications that the consumer desires. However, because IRD resources are limited, the operator may also wish to ensure that hardware and/or software resources remain available for those applications which are furnished by the operator. In order to ensure adequate resources are available for the operator provided applications, the operator may configure the IRD with a trusted, application-level resource advisor which may be used to resolve contention for resources. In one embodiment, both the resource advisor (which may be partially implemented as hardware) and interactive applications execute in the IRD (or IRD containing device such as a set-top box). While the following description frequently references a set-top box or IRD, it should be understood that the principles of the method and mechanism described herein may apply to other devices where the network operator is to be in control of the resource allocation within the device. Also, the resource advisor may be transmitted by means other than broadcasting, such as multicasting and point-to-point connections.

Like application-level software, the resource advisor may consist of software. However, the resource advisor may also be implemented in hardware, or a combination of hardware and software. For example, in one embodiment a resource advisor may comprise a hardware component which is plugged in to a set-top box or other device. Unlike other application-level software, the resource advisor may have special privileges to access APIs that control or advise the OS or middleware.

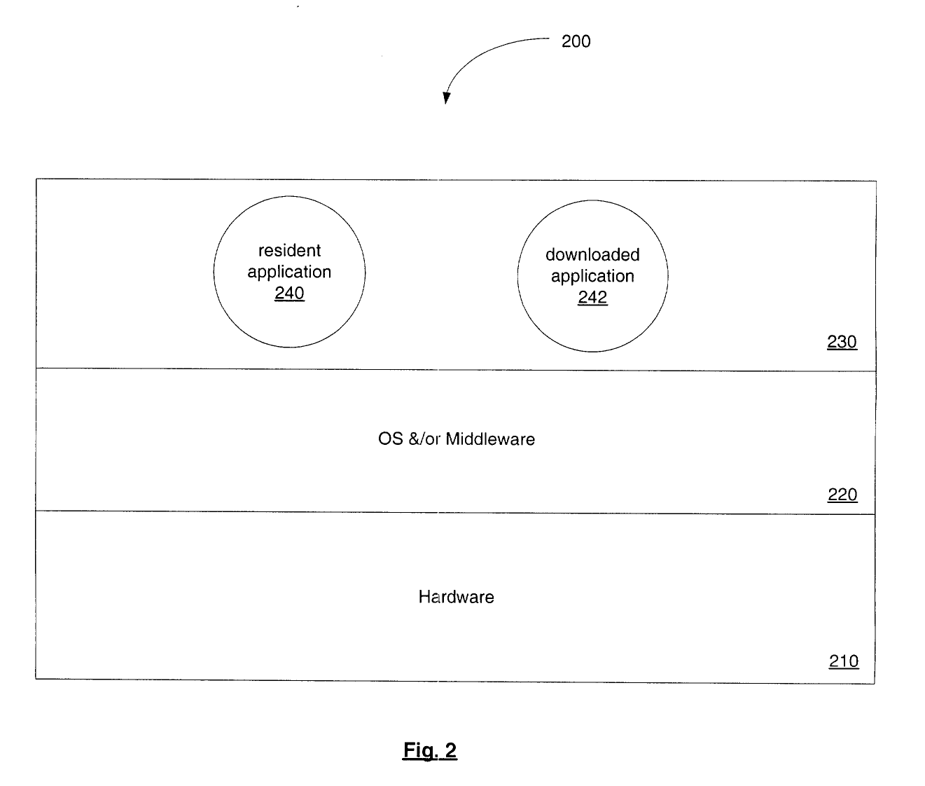

FIG. 2 illustrates one embodiment of an IRD architectural model 200 that does not use the trusted, application-level IRD resource advisor. Illustrated in FIG. 2 are a hardware layer 210, OS and/or middleware layer 220, and application layer 230. Application layer 230 includes a resident application 240 and a downloaded application 242. The hardware layer 210 includes resources such as memory and processing which are utilized by the OS and/or middleware within layer 220, and the application layer 230. In the embodiment shown, all resource allocation decisions are made by the OS/middleware 220. If a network operator wishes to influence the resource allocation decisions made within IRD 200, they must cooperate with the manufacturer of the IRD 200. Typically this cooperation requires the installation of an OS/middleware which implements their resource management policy within the IRD 200. If they wish to change the policy, then a new version of the OS/middleware 220 must be downloaded to the IRD 200. Such modifications can require extensive testing of the new OS/middleware and also require that a large executable remain available until all IRDs furnished by the operator have downloaded the new version.

The difficulty of upgrading software in a broadcast environment is compounded by the nature of the system. It may be necessary that the software to be reinstalled be continually broadcast if there is no mechanism available to allow downloading via a return channel. Even if there is a return channel, a signal to indicate availability of the new version must be broadcast repeatedly because not all IRDs will necessarily be turned on at the same time. In addition, use of the new features implemented by the new software would likely be delayed until a substantial percentage of the IRDs had been upgraded.

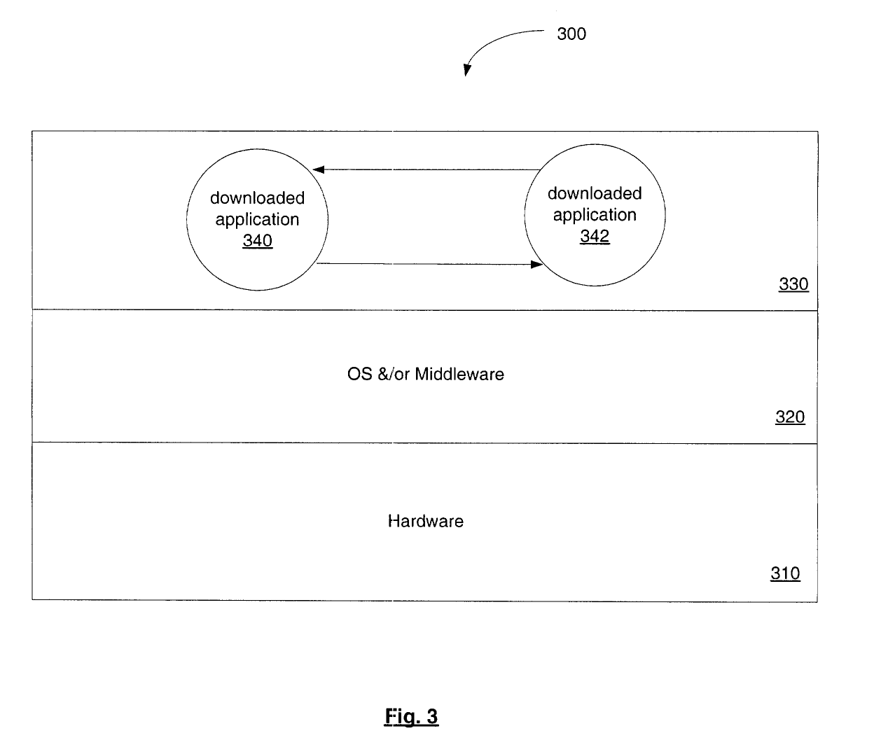

FIG. 3 illustrates a second model 300 wherein a resource advisor is not used. Similar to FIG. 2, FIG. 3 includes a hardware layer 310, OS and/or middleware layer 320, and application layer 330. Application layer 330 includes a first downloaded application 340 and a second downloaded application 342. In the architectural model 300 of FIG. 3, it is assumed that (1) if applications 340 and 342 are to share resources, they will be specifically written to share resources properly; or (2) the OS and/or middleware 320 may allocate resources based upon application priority or manufacturer policy. Like the model 200 illustrated in FIG. 2, in order to influence resource allocation decisions made in model 300, the operator would be required to integrate their policy with the OS/middleware and download the well-tested, integrated software (if all possible concurrent applications have not been designed to cooperate with one another by the operator or their contractors/subcontractors).

Resource Management

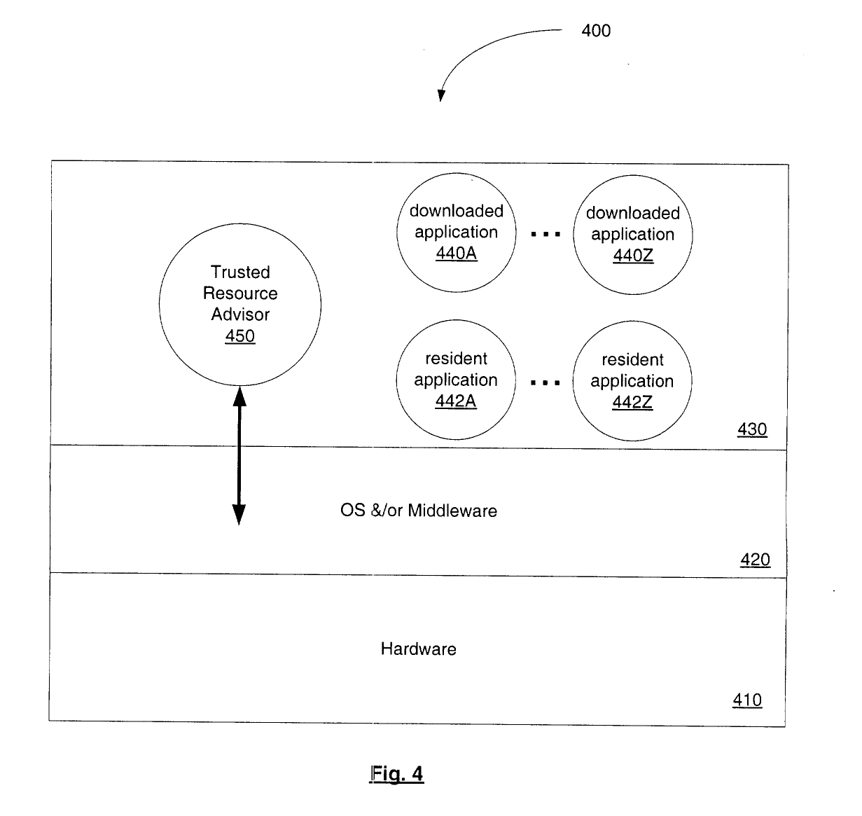

Turning now to FIG. 4, one embodiment of an architectural model 400 which utilizes a trusted, application level resource advisor 450 to affect resource allocation is shown. Similar to FIGS. 2 and 3, FIG. 4 includes a hardware layer 410, OS and/or middleware layer 420, and application layer 430. Application layer 430 may include both resident applications 442 and downloaded applications 440. However, in addition, application layer 430 includes a trusted resource advisor 450 application. Trusted resource advisor 450 is permitted to make resource allocation decisions, according to the operator's policy. In this manner, the operator may implement a resource allocation policy without requiring a new middleware or operating system implementation to be downloaded. In one embodiment, the operator furnishes the resource advisor via download to the IRD. Alternatively, if policy is expected to change relatively infrequently, it may be beneficial to furnish the customer with a hardware component that embodies the resource advisor 450, such as a plug-in smart card. It is also noted that although the trusted resource advisor is shown in the application layer 430, it may be possible for only a component of the advisor to exist at the application layer. That is, for example, software in the OS and/or middleware may comprise part or all of the executable portion of the resource advisor, with policy information, perhaps as data or as software that invokes api's on the lower level portion of the resource advisor, passing parameters that indicate policy. Similarly, the resource advisor may have components in each of the three layers, e.g., a smart card in the hardware, special api's in the OS and/or middleware, and data at the application layer.

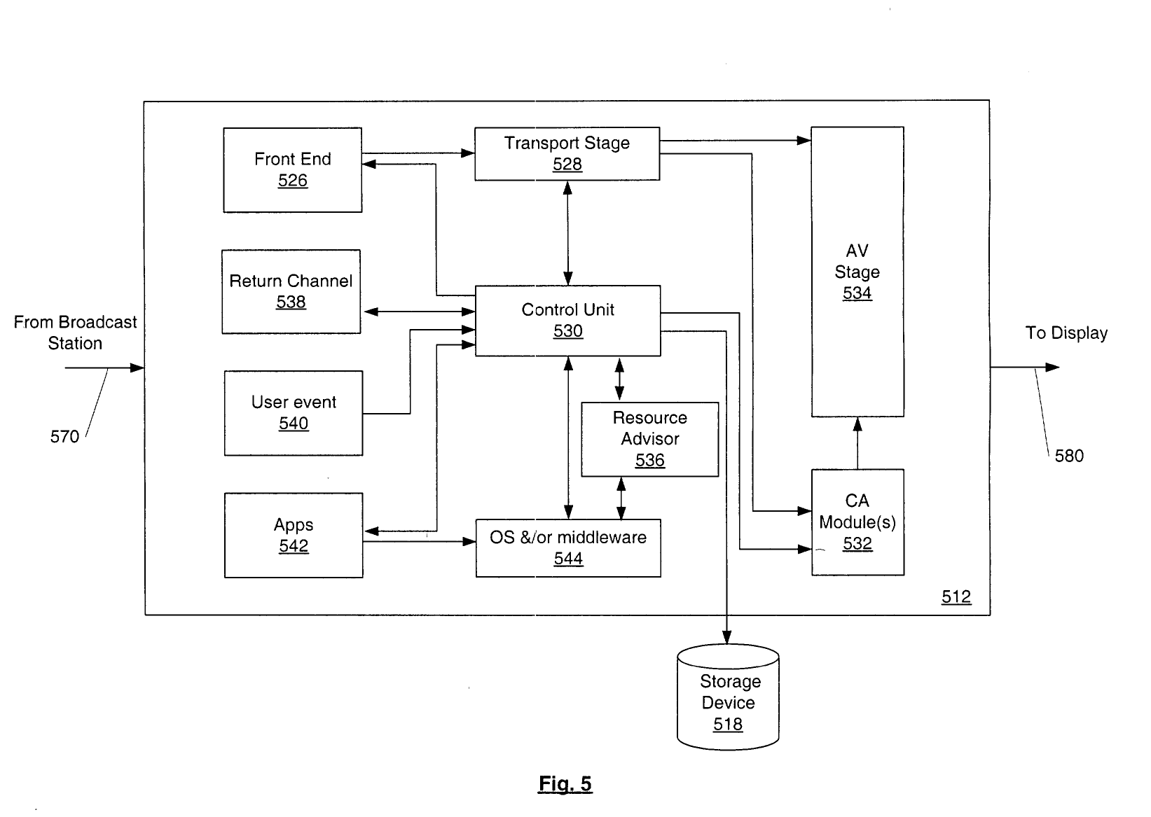

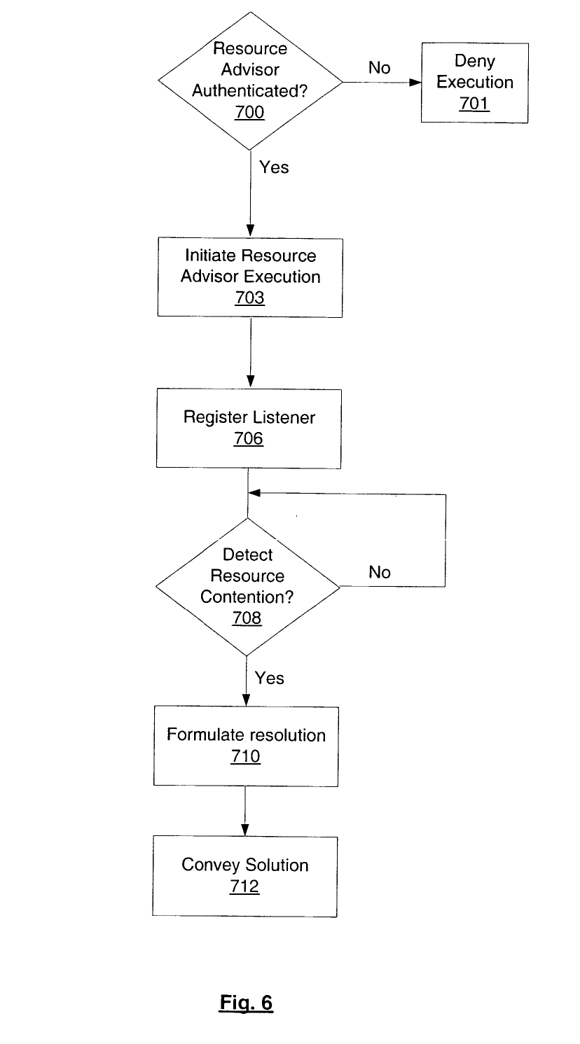

Turning now to FIG. 5, one embodiment of an IRD 512 including a resource advisor 536 is shown. FIG. 6 illustrates the IRD 512 in the form of a set top box 512. However, as mentioned above, IRD 512 may be incorporated into any other suitable device. Set-top box 512 is configured to receive a first signal 570, such as a broadcast signal, and convey a second signal 580, such as to a display device. In the embodiment shown, set-top box 512 is coupled to a storage device 518.

Set-top box 512 includes a control unit 530, front end 526, return channel 538, transport stage 528, and AV stage 534. Also represented in FIG. 6 are an event 540, applications 542, OS and/or middleware 544, conditional access (CA) module(s) 532, and resource advisor 536. Event 540 represents any event which may be detected by set-top box 512. Such events may be caused by an external event, such as user interaction, or an internal event, such as software or hardware operation. Control unit 530 may comprise a microprocessor, memory (e.g., RAM), and other components which are necessary to perform ordinary general purpose computing. In one embodiment, applications 542, OS/middleware 544, CA module(s) 532, and resource advisor 536 comprise code which may be stored in a memory device of set-top box 512. Additionally, applications 542 and resource advisor 536 correspond to application layer 430 of model 400 and OS/middleware 544 may correspond to layer 420 of model 400. In one embodiment, OS/middleware 544 comprises a rudimentary real time operating system configured to perform limited functions such as driver interfaces and optionally includes additional middleware. Additionally, CA module(s) 532 may comprise system software configured to control access to particular programs or services which are accessible by set-top box 512. Hardware components of set-top box 512 may correspond to layer 410 of model 400.

Generally speaking, set top box 512 may be operable to receive and decompress signals including digital data. The decompressed signals may be converted into analog signals such as NTSC (National Television Standards Committee) format signals for television display, or may be in digital format for use by a digital television display. As shown in FIG. 6, set-top box 512 includes front end circuitry 526 operable to receive audio, video, and other data from a received signal 570. The received signal 570 is fed into the set top box 512 at the front end 526, which may comprise an analog to digital (A/D) converter and tuner/demodulators (not shown). Front end 526 may select and pass a particular frequency, demodulate it, and convert it to a digital format. The digitized output is then conveyed to a transport stage 528. Transport stage 28 further processes the data, conveying a portion of the data to an audio-visual (AV) stage 534 for display and another portion to control processor 530. In addition, CA module 532 may receive data from transport stage 528 and may conditionally convey a descrambled or other signal to AV stage 534. Signaling and control information may also be included in the broadcast along with the audio-video data and may be manipulated by software within the set-top box 512.

Audio-video signals and program control signals received by the set top box 512 may include television programs and menu selections accessible by a viewer through a user interface, as well as applications that may be executed. A viewer may control the set-top box 512 in a variety of ways, including through an infrared remote control unit, a control panel on the set top box, or a menu displayed on the television screen. Selections and entries made by the viewer may be intended for one or more of several applications that are executing on the set-top box. As mentioned above, broadcast signals 570 are received via front end 526 and are filtered by transport stage 528. Unicast or multicast signals may generally be received via return channel 538. Applications 542 which execute on the set-top box 512 may arrive there in a variety of ways. For example, applications may be received via a broadcast signal 570, via the return channel resource interface 538, or via storage device 518. Applications received via storage device 518 may have been shipped originally with the set-top box 512 or may have been downloaded previously from another source and stored on storage 518.

In one embodiment, set-top box 512 may be configured as a digital set top box for use with a satellite receiver or satellite integrated decoder/receiver that is capable of decoding MPEG video, audio, and data. For example, set top box 512 may be configured to receive digital video channels that support broadband communications using Quadrature Amplitude Modulation (QAM) and to control channels for two-way signaling and messaging. The digital QAM channels may carry compressed and encoded multiprogram MPEG (Motion Picture Expert Group) transport streams. Transport stage 528 extracts the desired program from the transport stream and separates the audio, video, and data components, which are routed to devices that process the streams, such as one or more audio decoders, one or more video decoders, and optionally to RAM (or other form of memory) or a hard drive. It is to be understood that the set top box 512 and storage device 518 (as well as any data and signals from the broadcast service provider) may be configured to accommodate analog, digital, or both analog and digital data.

Storage device 518 is optionally coupled to the set top box 512 and may be configured to store video, audio, programs and other data. Storage device 518 may be internal to set-top box 512 or connected externally (e.g., through an IEEE 1394-1995 connection) with either a permanent connection or a removable connection. Further, storage device 518 may comprise any suitable storage type of storage, such as a hard disk drive, a recordable DVD drive, magnetic tape, optical disk, magneto-optical disk, flash memory, or solid state memory. More than one storage device 512 may be attached to the set top box 512. The set top box 512 and/or storage device 518 may further be incorporated into a television set. Applications which are stored within storage device 518 may be retrieved and executed. In one embodiment, retrieved applications may execute in synchronization with other applications or received signals, for example corresponding to a game show, commercial, or Internet based on-line game. Alternatively, retrieved applications may execute independently, such as for video-on-demand, banking, e-mail, or an electronic program guide (EPG).

When an event 540 is detected, data corresponding to the event may be received, or generated, which is targeted to one or more applications within set-top box 512. One of the decisions that needs to be made by the resource management component of the system is to determine which of several applications requesting exclusive control of a resource should be granted that control.

It is to be understood that the set-top box 512 and system 1000 described herein are intended to be exemplary only. Broadcast network system 1000 and set-top box 512 may be different than described herein without departing from the scope of the invention. For example, set-top box 512 may be configured differently. Further, various components depicted in the set top box 512 of FIG. 6 may be combined, such as the placement of the integration of storage device 518 within set top box 512. Numerous alternatives are possible and are contemplated.

Trusted, Application Level Resource Advisor

Turning now to FIG. 6, a general overview of one embodiment of a method for managing resources using a resource advisor in accordance with the description herein is shown. Prior to attempting execution of a resource advisor (block 703), authentication of the resource advisor is performed (block 700). In one embodiment, authentication may include verifying that the resource advisor is authenticated by the operator to execute with access to privileged APIs. If the resource advisor fails the authentication procedure, execution of the resource advisor is denied (block 701). On the other hand, if the resource advisor is authenticated, the advisor may begin execution.

Upon being permitted to execute, the resource advisor may register a listening component (block 706) with the operating system and/or middleware. Generally speaking, the listening component is configured to receive notification of resource contention. If resource contention is detected (block 708), the resource advisor is configured to formulate a resolution. The decision made by the resource advisor is then conveyed to the operating system and/or middleware (block 712) for implementation of the solution.

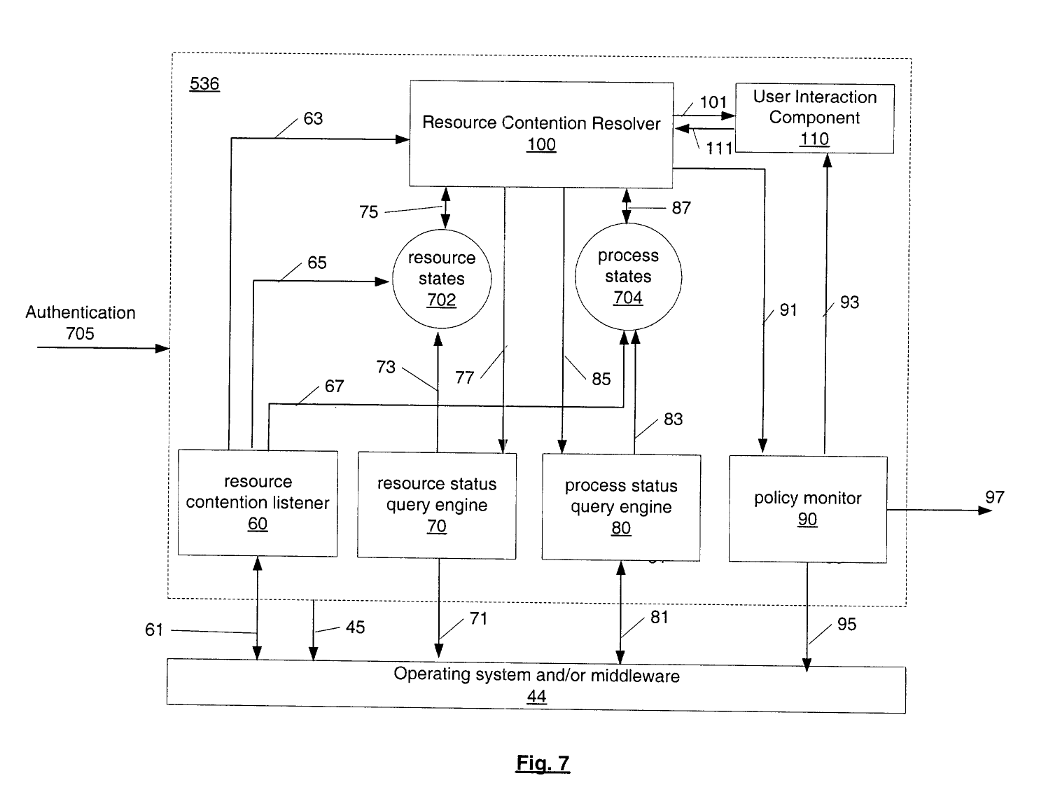

Turning now to FIG. 7, one embodiment of a resource advisor 536 coupled to an OS/middleware layer 44 is illustrated. In the embodiment shown, resource advisor 536 includes a number of components, including a resource contention listener 60, a resource contention resolver 100, a resource status query engine 70, a process status query engine 80, a user interaction component 110, and a policy monitor 90. Additionally, some authentication 705, perhaps similar to a credential, may be utilized to authenticate to the operating system and/or middleware that the resource advisor is trusted by the operator to affect resource allocation decisions.

In the embodiment shown, resource contention listener 60 may be configured to register with the OS/middleware layer 44 so that it may be informed when resource contention occurs. In one embodiment, during registration the resource contention listener 60 may indicate whether it should be notified before or after any negotiation between a requesting and an owning application. Resource status query engine 70 and process status query engine 80 are configured to determine the resource and operating status of the IRD 512 and may maintain an internal representation of the determined status as indicated by resource states 702 and process states 704. Resource contention resolver 100 can use the current status along with its programmed policy to make resource allocation decisions. Optionally, it can present choices to the viewer, simply inform the viewer of its assessment or not interact with the viewer at all. Upon arriving at an allocation decision, the resource contention resolver informs the operating system and/or middleware of that decision via the policy monitor.

One embodiment of a resource advisor 536 is described as follows. Because the resource advisor must have access to APIs that could be dangerous if they were accessible to any application that was downloaded onto the IRD, the IRD must be able to authenticate that the operator has authorized the resource advisor to have access to these APIs. Consequently, before the resource advisor 536 is allowed to affect resource allocation within a device, it first seeks authorization or is otherwise authenticated as being trusted. In one embodiment, authentication includes verifying that the resource advisor 536 application code is authenticated by the operator to execute with access to privileged APIs. One way to verify that the application is trusted is to include a credential from the operator. One mechanism for utilizing credentials is described in U.S. Pat. No. 6,038,319, issued Mar. 14, 2000, entitled “Security model for sharing in interactive television applications” by Suresh N. Chari, which is incorporated herein by reference in its entirety.

Utilizing an authentication mechanism is particularly useful if the operator decides to delegate the construction of a resource advisor to a third party. In that case, the operator may provide a digitally signed permission to the third party. When the third party packages the resource advisor for distribution, the third party may include a credential, digitally signed by that same third party, which includes the permission which was signed by the operator. Once the credential has been successfully authenticated by the set-top box, it can allow the resource advisor to execute, permitting it access to special functionality.

For example, credentials may be used in a 3-components model: grantor, grantee, resource or permission granted. In one embodiment, the grantor may be a standards body (e.g. DVB) or consortium (e.g. eP in Japan) which is responsible for the proper functioning of a population of receivers. The grantee may then be a network operator, and the resource or permission granted is the capability to act as a resource advisor on these receivers when they are used on the specific network. Consequently, there could be several resource advisors on one receiver: the one used would depend on the network to which a viewer is connected. On the other hand, if the network operator “owns” the receiver (i.e. the STB is designed to work only with one network and contains a root certificate from the network), then credentials may not be needed. In such a case, certificates may be sufficient for authenticating the resource advisor.

In one embodiment, after successful authentication, the resource advisor 536 begins to execute, perhaps concurrently with other applications. In an alternative embodiment, authentication may be performed subsequent to execution, but prior to allowing the resource advisor to affect resource usage. The resource advisor first registers to receive indications whenever resource contention occurs. In one embodiment, the resource advisor need not take any other action then until its resource contention listener 60 is notified that resource contention has occurred. Upon such notification, it assesses the situation. In one embodiment, the notification can include details concerning the contention that occurred, such as which processes (applications in execution) are involved and which resources are the subject of contention. Alternatively, the resource advisor may query, using engines similar to the resource status query engine 70 or the process (app) status query engine 80, for this information or other information, such as the location from which the application represented by one of the contending processes was obtained and store the relevant information in some internal representation, such as in a field within an object local to the resource advisor. The resource contention resolver 100 could then use information about the processes, the resources, as well as operator-specific information to determine how to resolve the resource contention. In one embodiment, the contention resolver 100 may even ask the user, via its optional user interaction component 100, for advice or present an imminent resource allocation action that the resource advisor is about to undertake to the viewer.

In one embodiment, after a decision is made (perhaps based on a revenue model, viewer preferences, etc.), the policy monitor 90 informs the operating system and/or middleware how to resolve the resource contention. Examples of resolution may include one or more of the following:

denying a process's request for a new resource;

pausing a currently executing application;

terminating a currently executing process;

beginning execution of a different version of a currently execution application;

removing a resource from a process that currently has it, either temporarily or permanently;

requesting that a currently owning process release a resource;

notifying a head-end server or load balancer;

making a request to an altogether different process to take an action which frees up some resources, for example an application that asks the viewer if they wish to change the channel or delete a previously made recording; or

do nothing.

In addition to informing the operating system and/or middleware concerning the resolution, the policy monitor 90 may use the user interaction component 110 to inform the viewer of the decision.

The “do nothing” solution might be used if the viewer is attempting to only execute several applications that they had downloaded from elsewhere and about which the network operator had no knowledge; in such a case, it might be assumed that the viewer is a more sophisticated viewer that prefers not to have their resources controlled by the system operator. Since, for example, in this case there would be no revenue lost by the operator in allowing the viewer to control the resources, allowing the viewer and/or operating system or middleware to determine a solution on its own has no repercussion for the operator.

Notification to the head-end server and/or load balancer could be useful under several circumstances. For example, if the return channel is a bottleneck, and many viewers attempt to access the same site simultaneously, the head-end may choose to carousel the requested data instead. Alternatively, if the section filters are the limited resource, a particular object may be sent through a return channel. If CPU time is at a premium, the head-end or proxy server may choose to render the data there and send an MPEG still, and, at the opposite end if the video decoder is the most limited resource, and an IRD has substantial CPU capabilities, the server may replace the MPEG still with data to be rendered.

FIG. 7 illustrates in one embodiment, using arrows, the interactions of various components with each other in the resource advisor. Arrow 45 represents an indication that the resource contention listener is prepared to receive notification that resource contention has occurred. This interaction need not be explicit; in one embodiment the operating system and/or middleware may deliver notification of resource contention to any privileged application without requiring that the application register its readiness. Arrow 61 represents the operating system and/or middleware notifying the Resource Advisor's contention listener that resource contention has occurred. Such notification could contain data relevant to the contention. If it does contain such data, that data may be sent directly to the resource contention resolver via 63 when the resource contention listener indicates to the resolver that the a resolution is needed. Alternatively, the resource contention listener could simply translate the data into an internal representation as shown in connections 65 and 67, which could later be used by the resource contention resolver.

In one embodiment, if the resource contention resolver does not receive information concerning the applications and resources involved in the resource contention in the interaction labeled 63, it may communicate with a resource status or process (app) status query engine as shown in 77 and 85. These query engines, in turn, may request corresponding status information from the operating system and/or middleware via 71 and 81. In one embodiment the information provided via 71 and 81 will only be relevant to the applications and resources which are actually involved in the resource contention. For example, if one application, A, has exclusively reserved some specialized hardware MPEG filters, F₁ and F₂, and another application, B, requests the same filters, then only information about A, B, F₁, and F₂ would be returned to the appropriate query engines. So, for example, the information that application C currently holds a different type of filter, F₃, would not be returned.

Other relevant information might include the current states of the various applications, for example, that application A is in a paused state, what caused A to enter the paused state, and that application B is in an active-state. These engines may reply directly with relevant information to the resource contention resolver or may store the state in an internal representation according to arrows 73 and 83. If an internal representation is stored, it may be afterwards viewed by the resource contention resolver via 75 and 87. Based on this information, the resource contention resolver may be able to determine what action to take to resolve the contention. Alternatively, it could use connections 101 and 111 to obtain viewer input concerning the actions that should be taken. In another embodiment, it could use 101 to inform the viewer of the action to be taken. After a decision is made, it can be related to the operating system and/or middleware layer via the policy monitor (91 and 95). It is possible that the policy monitor could be responsible for, via a user interaction component 93, notifying a viewer of the resolution action prior to, or in conjunction with notifying the operating system and/or middleware of the resolution action via 95. In another embodiment, it is possible that the policy monitor will perform the actions itself on the other applications, e.g., asking them to terminate or release resources, rather than requesting that the operating system and/or middleware perform these actions. According to such an embodiment, the policy monitor could inform the operating system and/or middleware of the action after or concurrent with taking the action. Alternatively, it could allow the operating system and/or middleware to deduce the actions when informed of them by the processes (apps) that are affected by them.

It should be understood that the above-described components (60, 70, 80, 90, 100, 110), including the connections between them, may be implemented as different modules within a single process, as an integrated whole, or as any combination thereof. They may also be further subdivided into more components. If implemented as multiple modules, they may be instantiated as separate threads within a single executing application, or as separate applications that communicate with one another or are placed together in a single thread of an executing application.

Various embodiments may further include receiving, sending or storing instructions and/or data implemented in accordance with the foregoing description upon a carrier medium. Generally speaking, a carrier medium may include transmission media or signals used in broadcast systems and otherwise such as electrical, electromagnetic, or digital signals, conveyed via a communication medium such as network and/or a wireless link. For example, a network operator may convey signals which describe application instructions via a broadcast system. A carrier medium may also include storage media or memory media such as magnetic or optical media, e.g., disk or CD-ROM, volatile or non-volatile media such as RAM (e.g. SDRAM, RDRAM, SRAM, etc.), ROM, etc.

While the present invention has been described with reference to particular embodiments, it will be understood that the embodiments are illustrative and that the invention scope is not limited to these embodiments. For example, while discussed in terms of television systems, the invention may also be used in the context of a device coupled to the Internet, such as a personal computer or video game platform. In such an embodiment, a user may have a broadband connection to the Web, such as via cable modem or DSL whereby programs, interactive applications and scripts are received. Further, rather than utilizing a remote control, a user may use a mouse, voice recognition apparatus, or otherwise to convey an indication. Many variations, modifications, additions and improvements to the embodiments described are possible.

In the pages which follow, one embodiment of an Application Programming Interface (API) for use in employing the above described method and mechanism is shown. While the exemplary embodiment shown utilizes the Java® programming language, it is understood that other languages may be used. Further, other classes, methods, and/or interfaces may be used than those which are shown.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for controlling resources in a receiving device, the method comprising:
authenticating a resource advisor in the receiving device;
initiating execution of the resource advisor;
said resource advisor detecting resource contention within the device;
said resource advisor formulating a solution to the resource contention; and
conveying an indication of the solution to an OS/middleware of the device.

2. The method as recited in claim 1, further comprising downloading said resource advisor to said receiving device.

3. The method as recited in claim 2, wherein said receiving device comprises a set-top box coupled to download said resource advisor via a broadcast signal.

4. The method as recited in claim 2, wherein the resource advisor comprises application code executing at an application level.

5. The method as recited in claim 4, wherein the resource advisor is accompanied by a credential corresponding to a network operator, wherein authenticating the resource advisor comprises verifying the credential.

6. The method of claim 2, wherein the solution is selected from the group consisting of: denying a request for a new resource; pausing a currently executing application; terminating a currently executing process; beginning execution of a different version of a currently execution application; removing a resource from a process that currently has it; requesting that a currently owning process release a resource; notifying a head-end server or load balancer.

7. The method as recited in claim 4, wherein the resource contention corresponds to a first application and a second application, wherein the first application and second application were not written to arbitrate with each other for resources.

8. A trusted, application level resource advisor for use in a receiving device, the resource advisor comprising:
a contention detection component configured to detect resource contention within the receiving device;
a contention resolution component coupled to receive data corresponding to the detected resource contention, wherein the resolution component is configured to formulate a resolution to the detected resource contention; and
a policy component configured to convey an indication of the resolution to an OS/middleware.

9. The resource advisor as recited in claim 8, further comprising a resource status query component configured to determine a status of resources corresponding to the receiving device.

10. The resource advisor as recited in claim 8, further comprising a process status query component configured to determine a status of an application process in the receiving device.

11. The resource advisor as recited in claim 8, wherein the resource advisor comprises application code including a credential which corresponds to a network operator.

12. The resource advisor as recited in claim 11, wherein the credential comprises a digitally signed permission.

13. The resource advisor as recited in claim 11, wherein the contention detection component comprises a listener, wherein said advisor is configured to register the listener with the OS/middleware to be notified of resource contention within the device.

14. The resource advisor as recited in claim 11, wherein the resource advisor comprises application code downloaded to the receiving device from a network operator.

15. The resource advisor as recited in claim 14, wherein the policy component is configured by the network operator to affect resource usage in accordance with the desires of the network operator.

16. A system for controlling resource usage comprising:
a first source configured to convey a resource advisor, the resource advisor comprising application instructions for execution within a receiving device, the application instructions being executable to:
detect resource contention within the receiving device;
formulate a resolution to the detected resource contention; and
convey an indication of the resolution to an OS/middleware component of the receiving device.

17. The system as recited in claim 16, wherein the first source is configured to convey the resource advisor via a broadcast signal.

18. The system as recited in claim 17, wherein the receiving device is configured to authenticate the resource advisor prior to allowing the resource advisor to affect resource usage with the receiving device.

19. The system of claim 18, wherein the resource advisor is configured for execution at an application level, and wherein the resource advisor is configured to be executed on each of a heterogeneous collection of receivers.

20. A carrier medium comprising application instructions, wherein the application instructions are executable to:
detect resource contention within a receiving device;
formulate a resolution to the detected resource contention; and
convey an indication of the resolution to an OS/middleware component of the receiving device.

21. The carrier medium as recited in claim 20, wherein the application instructions are further executable to register with the OS/middleware to be notified of the resource contention within the receiving device.

22. The carrier medium as recited in claim 20, wherein the application instructions are executable to affect resource usage in accordance with the desires of a network operator.

23. The carrier medium as recited in claim 20, wherein the application instructions comprise a corresponding credential, and wherein the receiving device is configured to authenticate the credential prior to allowing the program instructions to affect resource usage within the receiving device.
